(19) United States
(12) Patent Application Publication
(10) Pub. No.: US 2004/0230710 A1
(43) Pub. Date: Nov. 18, 2004

(54) System and method of automatic installation of computer peripherals

(75) Inventor: David D. Goodman, Washington, DC (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Inline Connection Corporation, Washington, DC (US)

(21) Appl. No.: 10/795,448

(22) Filed: Mar. 9, 2004

Related U.S. Application Data
(63) Continuation-in-part of application No. 09/619,958, filed on Jul. 20, 2000, now Pat. No. 6,704,824.
(60) Provisional application No. 60/145,836, filed on Jul. 27, 1999.
(60) Provisional application No. 60/479,911, filed on Jun. 20, 2003.

(51) Int. Cl. G06F 3/00

(52) U.S. Cl. 710/8

(57) ABSTRACT

One or more embodiments of the present invention provide a system and method for connecting peripheral devices to personal computers (PCs), and/or enabling communication between one or more peripheral devices and a PC, without requiring manually providing the PC with a communications driver or user-installed software needed to enable the PC to communicate with the peripheral device. The USB, 1394, and/or PCMCIA interfaces (or standards), for example, can be used to enable a peripheral device to communicate with the PC.

### CROSS-REFERENCE TO RELATED APPLICATIONS

This application is a continuation-in-part of U.S. application Ser. No. 09/619,958, filed Jul. 20, 2000, now U.S. Pat. No. 6,704,824, which claims priority to U.S. Provisional Application No. 60/145,836, filed Jul. 27, 1999, each of which are incorporated herein by reference. This application also claims priority to Provisional Application No. 60/479,911, filed Jun. 20, 2003, which is incorporated herein by reference.

### BACKGROUND OF THE INVENTION

Since the introduction of the IBM PC in 1983, computers have utilized serial, parallel, keyboard, mouse, Small Computer System Interface (SCSI) and/or Ethernet ports. When introduced in 1995, the Universal Serial Bus (USB) standard was intended to replace the various connectors found on standard personal computers (PCs). A description of the USB standard can be found in “Universal Serial Bus Specification Revision 2.0,” dated Apr. 27, 2000.

One application for USB communication is the connection of standard peripheral equipment to standard personal computers (PCs) that run, for example, a version of the Microsoft Windows® operating system (hereinafter Windows®). As used herein, a PC refers at least to both a personal computer and a laptop computer. Examples of such peripheral equipment include input/output devices such as keyboards, and communication devices such as modems, Ethernet network adapters, and wireless transceivers.

A second type of PC interface is called the 1394 digital link standard. The 1394 digital link standard was conceived in 1986 by Apple Computer, which referred to the 1394 digital link standard as “Firewire,” a name by which the 1394 digital link standard remains known and used today. The 1394 digital link standard was adopted in 1995 by the Institute of Electrical and Electronics Engineers (IEEE). The IEEE 1394 Standard is a high-speed serial bus standard for providing enhanced PC connectivity to a wide range of peripherals and devices. (USB, by definition, is also a serial bus.) Early applications included multimedia and video production as well as high speed hard drives. Rapid development of a greater variety of 1394-compliant peripheral devices (e.g., printers, hard drives, scanners, etc.) and widespread industry support has brought the IEEE 1394 Standard to mainstream users. Communication between PCs and 1394 peripherals can be facilitated by the use of cables that connect between standardized ports built into or utilized in connection with the hardware on each end.

A third type of interface, called PCMCIA, was established in June of 1989 by a non-profit trade association and standards body known as the Personal Computer Memory Card International Association (or simply PCMCIA). The PCMCIA standard was established with the intent of establishing, marketing, and maintaining a new expansion technology designed specifically for “on-the-road” computing. A credit card-sized casing was specified to house a new generation of expansion cards that would enable, for example, notebook and laptop users to add various capabilities to their respective computers. Hence the PCMCIA card, which has become more commonly known as the PC Card, was born.

PCMCIA cards are similar to USB and 1394-compliant peripherals in at least two ways. One similarity is that PCMCIA cards typically require the computer to access a driver in order to establish communication with them. A second similarity is called “Plug and Play.” PCMCIA cards can be inserted or removed while the system power is on because power and ground contact pins are the longest contacts, ensuring that data signals disengage first, thereby preserving data integrity.

The USB, 1394, and PCMCIA Standards not only specify low-level communication characteristics, but also specify how a peripheral device identifies itself to a host computer to which it is connected. In particular, when a peripheral based on any of the USB, IEEE 1394 and/or PCMCIA Standards is attached to a standard computer, a startup protocol is initiated in which the host computer receives the identity of the device.

Standard PCs use the identity of a device to obtain software that is specific to a peripheral, or to the class of peripherals, which share a common generic interface. This software is typically referred to as “driver” software, and it is useful, if not essential, in establishing low-level communication between the computer and the peripheral. For example, if a pointing mouse connects to the USB port of a host computer, the host computer must understand that the data it inputs through the port must be used to control the movement of a pointer across the computer display. It must therefore relay this data, in the correct form, to the part of a program (e.g., an operating system), which controls these movements.

FIG. 1. shows PCs running a version of the Windows® operating system, which searches for drivers in the following manner. When a USB device, such as a communication adapter 110, is first attached (or connected) to an interface 154 of a computer (PC) 150, processor 152 and/or the operating system executing on the PC 150 typically determines, based on the identification of the device it receives over the USB connection, whether it has access to the appropriate driver software for that device. Driver software can be stored in storage 156. If the driver software is not available for that device in, for example, storage 156, the operating system may request that the user insert a removable storage 160, such as a floppy disk or CD-ROM disk, that has the driver so that it can be installed onto computer 150. This procedure is typically used, for example, on the Microsoft Windows® 98 operating system. Once the communication adapter 110 can access the driver, communication adapter 110 provides communication services using the driver for communicating between PC 150 and, for example, other computers utilizing or accessing communication system 120, such as the Internet. Peripherals that implement alternative functions, of course, can also use this procedure, and the procedure described with reference to FIG. 1 also applies to peripherals that utilize the IEEE 1394 and PCMCIA Standards.

Drivers for some peripheral devices are preloaded on certain operating systems. For example, a generic keyboard driver, which supports keyboards from a variety of manufacturers, may already be loaded. If such a driver is already loaded at the time that a USB keyboard is attached to the host computer, under normal operating circumstances the user will not have to supply a specific driver for the keyboard, assuming the USB keyboard is compatible with the generic driver.

Often, communication between a PC and a peripheral can also benefit from software other than drivers. In particular, many peripherals are sold with programs, stored on one or more CD-ROM disks or other storage media, that the user installs on his/her PC. An example is a scanner that connects through a 1394 port. Basic communication between the scanner and the PC is provided by the software driver. A scanning program, however, is usually provided to allow one to use the PC screen, keyboard, and mouse to interact with the scanner, thereby enabling one to determine parameters such as scan resolution, image size, etc. Another function such a program could provide is the conversion of a scanned image to a different format and the storage of the image in a particular location.

### SUMMARY OF THE INVENTION

One or more embodiments of the present invention provide a system and method for connecting peripheral devices to computers, and/or enabling communication between one or more peripheral devices and a computer, without requiring of the additional step of manually providing the computer with a communications driver or user-installed software needed to enable the PC to communicate with the peripheral device. The USB, 1394, and/or PCMCIA interfaces (or Standards), for example, can be used to enable a peripheral device to communicate with computers. Embodiments of the invention, however, can also be used with peripherals that communicate across other types of interfaces, such as RS-232 serial ports, Centronix parallel ports, IRDA infrared ports and the new Bluetooth interface. In particular, one or more embodiments of the invention advantageously enable communication between a computer and one or more peripheral devices: (a) without requiring that a driver for the peripheral device be already available to the computer, (b) without requiring that the user provide storage media, (e.g., a CD-ROM disk or floppy disk) containing the driver, (c) without requiring software to be installed on the computer to coordinate upload of a driver, and/or (d) without upgrading the computer operating system. Additionally, at least one embodiment of the invention provides and facilitates installation of programs for enabling the user to utilize the functionality of the newly connected peripheral device.

One aspect or embodiment of the present invention is directed to a method for operating a peripheral device. The method includes operating the peripheral device to communicate with a computer, and transmitting an identification of one or more devices from the peripheral device to the computer. A method in accordance with the present invention can also emulate one or more devices whose identity was communicated by, for example, transferring a driver of a native device from the peripheral device to the computer. The peripheral device can send the identification of the native device to the computer, wherein the sent device identification is for a device supported by the native driver that was previously transferred through, for example, emulation. The peripheral device can provide the host computer with one or more programs, and instructions for installing them, which can be used by the user who interacts with the peripheral device when operating in native mode. The peripheral device can thus substantially operate as the native device and interact, using the native driver, with the computer.

Another embodiment of the present invention can include a processor that communicates with the computer through an interface. The processor can be programmed to (a) send the identification of one or more peripheral devices, (b) emulate those one or more devices, each of which stores a native driver and a program, (c) transfer a driver for a native type of device through the interface to the computer while emulating one or more devices, (d) provide the host computer with one or more programs to install, which will be useful for a user who interacts with the peripheral operating in native mode, and/or (e) operate as the native type of device after transferring the driver to the computer and/or installing the software on the computer.

### BRIEF DESCRIPTION OF THE DRAWINGS

FIG. 1 is a block diagram that illustrates a known approach to configuring a peripheral device.

FIG. 2 is an exemplary block diagram in accordance with an embodiment of the present invention that illustrates a system and method for configuring a peripheral device.

FIGS. 3A and 3B are exemplary diagrams in accordance with an embodiment of the present invention that shows how multiple mass storage devices of varying design can connect to a single communication port.

FIG. 4 is an exemplary flowchart of a method of operation of a peripheral device.

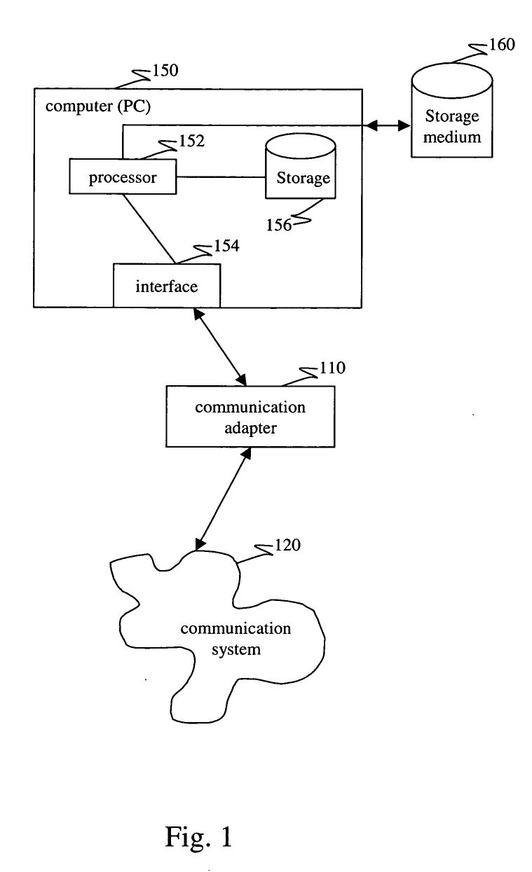

### DETAILED DESCRIPTION OF A PREFERRED EMBODIMENT OF THE INVENTION

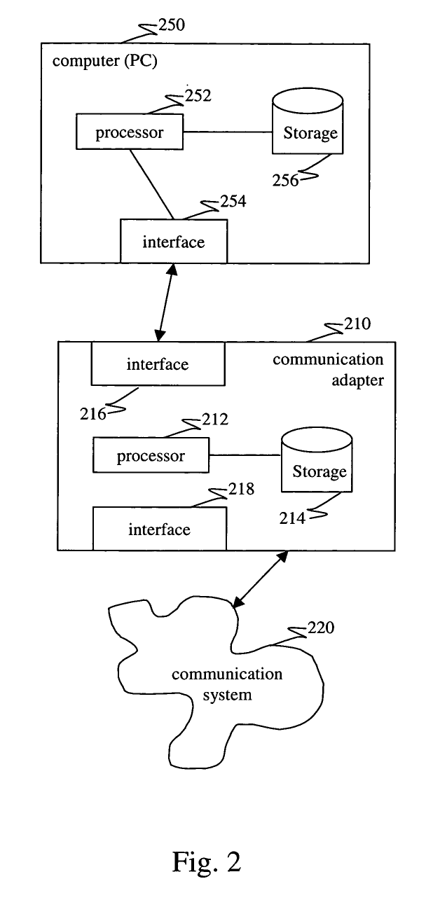

FIG. 2, generally at 200, shows an exemplary system that allows a peripheral device, such as communication adapter 210, to connect to and communicate with PC 250. PC 250 includes (or utilizes) an interface 254 for connecting peripheral devices, such as communication adapter 210, to PC 250. In at least one embodiment, interface 254 is a USB interface. In other embodiments, interface 254 can be, for example, an IEEE 1394 or a PCMCIA interface. The present approach can be used with other interfaces, such as RS-232 serial ports, Centronix parallel ports, IRDA infrared ports, and the new Bluetooth interface.

In one embodiment, the native mode of adapter 210 is a communication adapter, which provides a communication interface between PC 250 and communication system 220 such as the Internet, World Wide Web, or a local area network. In the native mode, communication adapter 210 can use interface 218 to facilitate or provide communication with communication system 220 using, for example, an Ethernet standard. In one or more embodiments, communication adapter 210 can use a standard other than the Ethernet standard such as the Token Ring Standard (the IEEE 802.5 Standard) for communicating over communication system 220. In one or more embodiments, peripheral devices such as such as RS-232 serial ports, Centronix parallel ports, IRDA infrared ports and the new Bluetooth interface can also be configured in accordance with the present invention.

Adapter 210 includes an interface 216 for communicating with PC 250. The design and operation of interface 216 will be compatible with interface 254. When adapter 210 is initially connected to interface 254, however, PC 250 may not have a suitable driver in storage 256 to operate adapter 210 in its native mode.

Communication adapter 210 also includes a processor 212, such as a micro-controller, and storage 214, such as standard semiconductor memory. Storage 214 holds software instructions that can be executed by processor 212. Generally, the instructions cause communication adapter 210 to operate in one of at least two operational modes. In a first mode, communication adapter 210 emulates one or more common peripheral devices for which a driver is already loaded in storage 256 on PC 250. In a second operating mode, which may be called the “native” mode, communication adapter 210 operates in another manner. In one embodiment, communication adapter 210 can operate to provide communication services that allow PC 250 to communicate with communication system 220. Alternatively, communication adapter 220 may operate, for example, as a scanner, a printer, a digital camera, a bar-code reader, or any other device that transmits data and/or control signals through, for example, interface 254.

When communication adapter 210 is initially connected to PC 250, adapter 210 (i.e., the peripheral device) can utilize the DC power that is available on the cable connecting to the port on the computer. (The USB, 1394, and PCMCIA ports on PCs all provide power to connected peripherals.) In one embodiment, processor 212 can start by emulating a single mass storage device, such as a CD-ROM drive, whose driver is available on, for example, storage 256. As part of that emulation, processor 212 can transmit data to PC 250 that identifies the adapter, for example, as a CD-ROM drive. The emulated behavior includes the insertion of a disk that includes a file named autorun.inf. The emulated disk also includes the driver of the native mode of adapter (i.e., peripheral) 210.

The autorun.inf file is used by Windows® operating systems to execute, under certain conditions, the instructions contained therein. Execution typically begins without delay after the information in the autorun.inf file becomes available to or is recognized by Windows®. For example, under certain conditions, the autorun.inf file is executed when a CD-ROM disk, containing the autorun.inf file, is inserted into the bay of a CD-ROM drive.

Instructions in an autorun.inf file can, for example, guide PC 250 to retrieve the driver for the native mode of adapter 210 from storage 214 and place it into storage 256. The instructions in an autorun.inf file can also guide PC 250 in the installation of software that the PC operator would utilize in order to take of the functionality of the native mode functionality of adapter 210 (e.g., a peripheral device).

There are seven types of mass storage devices that are defined by Windows® operating systems. The types of mass storage are: removable drives, hard drives, CD-ROM drives, network drives, ramdisk drives, and two types of drives called “unknown” and “no root directory” drives. Windows® includes a value in its parameter registry that determines, for each type of mass storage device, whether an autorun.inf file stored on such a device will be automatically executed when it becomes available. Removable drives include floppy and zip drives, while ramdisk drives are areas of memory that the operating system is programmed, in some sense, to view as it views a hard drive.

When Windows® is initially installed, the registry value relating to autorun.inf execution usually enables automatic execution of the file in any CD-ROM drive, hard drive, or removable drive. A problem arises in that the value in this registry can change, sometimes unexpectedly, during normal use of the computer. For example, such a change might be created by programs executing under Windows®. This often inconveniences users who expect the autorun.inf files on their CD disks to execute as soon as the disk is loaded.

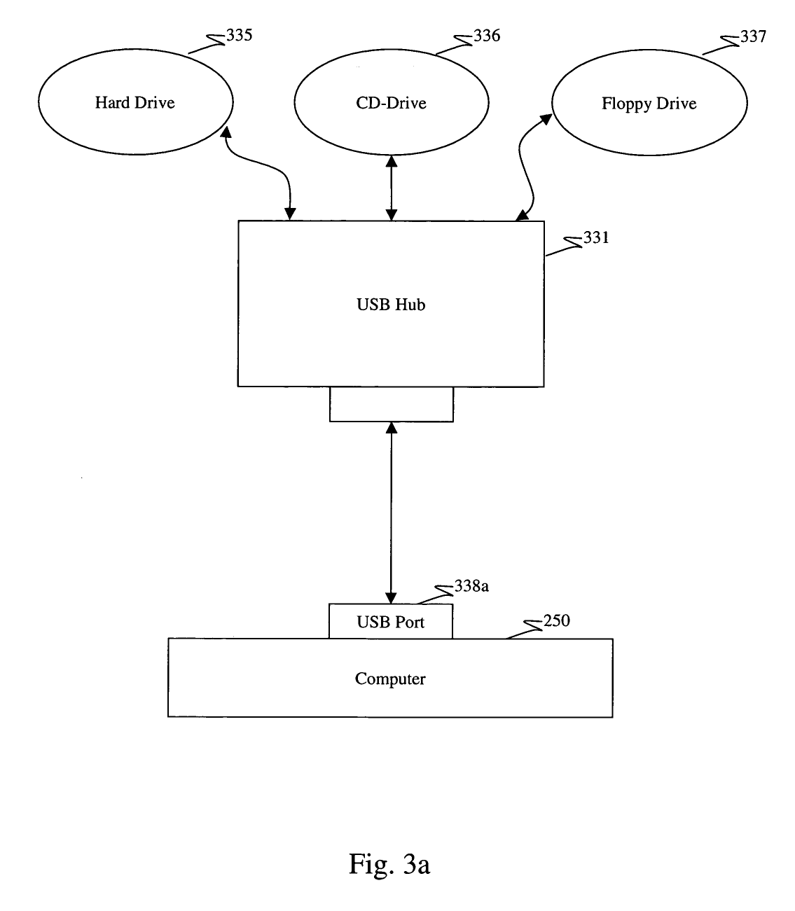

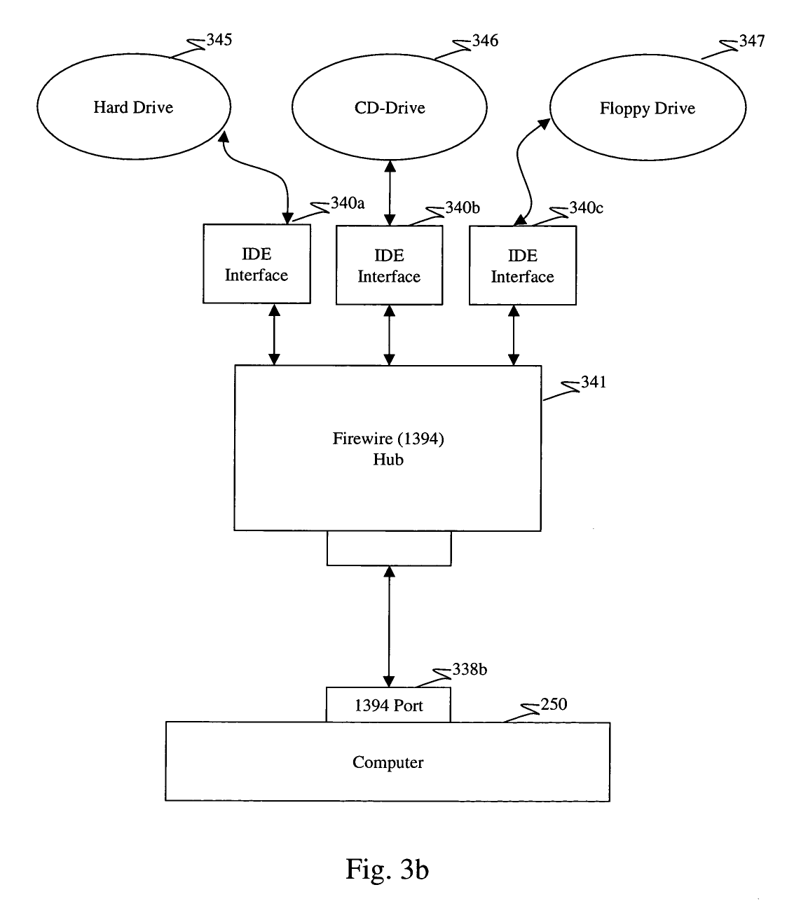

At least one embodiment of the present invention can substantially minimize the possibility that Windows® will not execute an autorun.inf file. The solution can include emulating one or more mass storage devices among the seven listed above, assuming that Windows® includes the driver associated with each emulated device. Each of the emulated drives can include an emulated autorun.inf file. Accordingly, in the event that the registry values, or some unforeseen problem(s) or event(s), cause(s) Windows® to not execute the autorun.inf file in all but one of the emulated mass storage devices, the desired driver will still be uploaded, and software installation will take place. Windows® XP, 2000, and ME—the three latest versions of Windows®—generally have the correct drivers. In particular, the drivers necessary for certain hard drives, CD-ROM drives, and floppy drives that connect to a USB port 338a shown in FIG. 3A are available in these operating systems. Moreover, drivers for a USB hub 331 are also stored in late-version Windows® operating systems. As a result, as shown in FIG. 3A, a USB device in accordance with at least one embodiment of the invention can emulate four devices: USB hub 331, hard drive 335, CD-ROM drive 336, and/or floppy drive 337.

When a “real” USB hub 331 and mass storage devices 335, 336, 337 are connected (as shown), only a single stream of data is transmitted between USB hub 331 (e.g., communication adapter 210) and PC 250. Thus, emulation of this configuration can be implemented by a single device—the connected peripheral—by creating a single stream that looks like the (data) stream a real hub produces when it combines the signals transmitted to and from three real devices.

After execution of the autorun.inf filefrom one of the emulated storage devices 335, 336, 337, the native driver and/or other application specific software will reside on PC 250. The USB peripheral, i.e., the USB device that connects to port 338a, can then begin to operate in its native mode, e.g., as a printer/scanner, digital camera, communication adapter, etc.

For the IEEE 1394 Standard, drivers for a 1394 hub and a 1394 “IDE interface” are provided in late-versions of Windows®. The IDE interface is designed for connection of mass storage devices 335, 336, 337. As a result, as shown in FIG. 3B, a 1394-compliant device can emulate, for example, IDE interfaces 340a, 340b, 340c, connected between IEEE 1394 hub 341, and hard drive 345, CD-ROM 346, and floppy drive 347.

An embodiment of a PCMCIA peripheral in accordance with the present invention can also emulate four devices. Such an embodiment would be analogous to FIGS. 3A and 3B, with, for example, a PCMCIA card used in lieu of USB hub 331, and USB port 338a being a PCMCIA port. In FIG. 3B, a PCMCIA card would be used in lieu of 1394 hub 341 and 1394 port 338b would be a PCMCIA port.

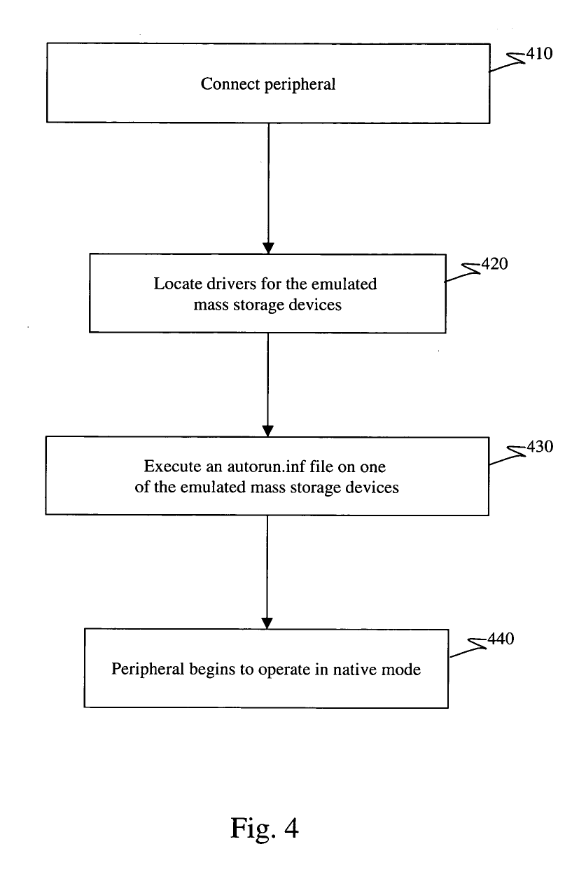

FIG. 4 is an exemplary method of operation of a peripheral device 210, such as a communication adapter, in accordance with the present invention. At step 410, if peripheral device 210 is plugged in to PC 250 while PC 250 is powered off, the peripheral device 210 begins its emulation during the start-up procedure. If the peripheral is plugged in when the PC 250 is powered, the emulating procedure can begin. Multiple devices can be connected to port 338a or 338b, through a respective hub 331 or 341, as described above, and multiple identifications can be uploaded to PC 250, optionally as part of the emulation.

At step 420, Windows® can search and/or acquire the driver(s) for these devices on storage 256, and use them to establish communication with peripheral 210. Windows® then recognizes, for example, hard drive 335, CD-Drive 336 and/or floppy drive 337, among the emulated devices with which it has established communication.

At step 430, Windows® begins to execute the autorun.inf file of one of the emulated devices 335, 336, 337 on which Windows® allows automatic execution. PC 250 will preferably, but optionally, be prevented during the execution of the autorun.inf file from starting a second process, in parallel, that executes the autorun.inf file on a different mass storage device. This prevents storing the driver twice and/or installing the software twice. Performing either of these procedures twice can create processing complications even if the two procedures are not done simultaneously.

To prevent multiple executions of autorun.inf, processor 212 on peripheral device 210 can react once it detects that PC 250 has begun executing the autorun.inf file on an emulated storage device. Processor 212 will be aware of the PC's 250 activity because it is aware of any “request” by PC 250 to read an emulated file, and it can control the transmission of data that are requested from the emulated storage device. Processor 212 can at this point terminate the emulation of any other mass storage device(s). Thus, processor 212 can prevent PC 250 from even beginning the execution of a autorun.inf file on a second device (e.g., CD-drive 336 and/or floppy drive 337).

The autorun.inf file also contains instructions that instruct or cause Windows® to determine whether the driver is already in storage 256, and whether the software is already installed (e.g., configured to operate with) on PC 250. If either of these conditions are satisfied, instructions in the autorun.inf file cause the computer to not perform an upload of the driver and/or not install the software. This advantageously alleviates peripheral device 210 from having to maintain and/or access data pertaining to steps taken on any particular computer.

The autorun.inf instructions can also direct (or cause) Windows® to communicate with processor 212, so the driver can be uploaded from storage 214 and installed on PC 250. After uploading, processor 212 can terminate any remaining emulations.

At step 440, processor 212 can commence native mode operation of peripheral device 210. In native mode operation, processor 212 can upload its identification to PC 250, which can locate the uploaded driver stored, for example, on storage 256, associated with the identification, and will use the uploaded driver to establish communication with peripheral 210.

In an embodiment of the present invention, storage 214 can optionally be writeable. This feature can enable, for example, the autorun.inf file to instruct Windows® to connect to a particular address on the Internet, and use information and instructions from that site to update storage 214. In such an embodiment, is not necessary that the connection between PC 210 and, for example, the Internet 220 be conducted through peripheral device 210. If the native mode of peripheral device 210 is a USB scanner, for example, and PC 250 connects to the Internet through, for example, a cable modem that connects to a 1394 port 338b, then processor 212 can communicate with the Internet 220 through that modem. The updating of storage 214 can, for example, replace the existing native driver with a new native driver.

In another embodiment of the invention, the autorun.inf file can instruct or cause Windows® to connect to a particular address on the Internet 220 and download a driver and/or software from that location into storage 256. The autorun.inf file can cause the download to be done automatically. Optionally, the autorun.inf file can instruct the computer to give the user the option of either proceeding with the download, or declining to proceed. In order to allow the location of the download site (on the Internet) to change from time to time, the autorun.inf file can be programmed to instruct Windows® to download from a named Internet address, e.g., “downld123.com”. Such an address can be mapped by a standard Domain Name System (DNS) server to the particular address where the driver and/or software can be downloaded. If and when this address changes, one has only to change the DNS mapping. The address change will be transparent to the download process initiated by the autorun.inf file. In other words, one must only alter the DNS mapping so that the named Internet address points to the new location.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described our invention, what I claim as new and desire to secure by Letters Patent is as follows:

1. A peripheral device, comprising:
a processor; and
an interface enabling said processor to communicate with a computer, wherein:
the computer, having a version of the Windows® operating system installed, automatically executes at least a portion of an instruction set in a file named autorun.inf that is stored on a mass storage device,
a storage medium readable by the computer comprises a driver for the mass storage device, and
upon receiving an identification of a device from said processor, the computer uses a driver for the identified device to establish communication, through said interface, with the identified device;
said processor transfers an identification of the mass storage device across said interface to the computer;
said processor emulates the mass storage device, the emulation comprising:
storing a file named autorun.inf, wherein said file comprises instructions that direct the computer to connect to the internet and to download a driver for a second device from a particular location on the Internet, and
said processor transmits the identification of the second device to the computer, and the peripheral device operates as the second device.
